(19) United States
(12) Patent Application Publication
(10) Pub. No.: US 2010/0053469 A1
(43) Pub. Date: Mar. 4, 2010

(54) METHOD AND APPARATUS FOR DIGITAL BROADCASTING SET-TOP BOX CONTROLLER AND DIGITAL BROADCASTING SYSTEM

(76) Inventor: Jung Yi Choi, Gyeonggi-do (KR)

Correspondence Address: EDWARDS ANGELL PALMER & DODGE LLP, P.O. BOX 55874, BOSTON, MA, 02205, US

(21) Appl. No.: 12/605,317

(22) Filed: Oct. 23, 2009

Related U.S. Application Data
(63) Continuation of application No. PCT/KR2008/002291, filed on Apr. 23, 2008.

(30) Foreign Application Priority Data
Apr. 24, 2007 (KR) 10-2007-0039942

(51) Int. Cl. H04N 5/44

(52) U.S. Cl. 348/734; 345/173; 348/E05.096

(57) ABSTRACT

An apparatus for controlling a digital broadcasting set-top box and a method of driving the apparatus are provided. The apparatus includes a touch pad which senses a touch of a user, converts the sensed touch into an input signal corresponding at least one of a location and a state of the sensed touch, and outputs the input signal; a micro control unit which receives the input signal from the touch pad and converts the input signal into a control signal; and a communication module which receives the control signal from the micro control unit and outputs the control signal to the digital broadcasting set-top box.

### CROSS-REFERENCE TO RELATED APPLICATION

This application is a continuation of PCT/KR2008/002291 filed on Aug. 23, 2008 which claims the benefit of Korean Application No. 10-2007-0039942 filed on Apr. 24, 2007, the entire contents of which are incorporated herein by reference.

### TECHNICAL FIELD

The present disclosure relates to an apparatus for controlling a digital broadcasting set-top box and a method of driving the apparatus. More particularly, it relates to a user interface device for controlling a digital broadcasting set-top box and providing various inputting methods.

### BACKGROUND ART

In the past, a one-way broadcasting system in which viewers only receive and watch broadcasting was mainly used. Nowadays, with the development of wireless communications and broadcasting technology, a digital broadcasting technique is used widely in, e.g., terrestrial broadcasting, cable broadcasting, and satellite broadcasting, and a two-way broadcasting system in which viewers give and receive predetermined demands to and from broadcasting providers via digital TVs or digital TV set-top boxes are introduced.

The two-way broadcasting system provide conveniences to viewers. For example, digital broadcasting set-top boxes can be connected to the Internet via a wired/wireless communication network, and viewers (users) can access necessary information from the Internet by using set-top boxes and TVs instead of using computers. In addition, in case of viewer-participation broadcasting, viewers can transmit messages, such as characters, to broadcasting providers.

While digital broadcasting services using such a digital broadcasting set-top box become diversified and improved in quality, a set-top box controller or an input device has not greatly improved compared with that in existing analog broadcasting or one-way broadcasting. In addition, although digital broadcasting set-top boxes can communicate with an existing wireless keyboard or mouse and can thus be controlled thereby, most of viewers desire to watch broadcasting in comfortable postures on the sofas. Thus, it is difficult for viewers to use an input device such as a keyboard or a mouse which is big and requires a flat surface.

### SUMMARY OF DISCLOSURE

According to an aspect of the present invention, there is provided a digital broadcasting set-top box controlling apparatus comprising: a touch pad that can sense a touch of a user, convert the sensed touch into an input signal corresponding at least one of a location and a state of the sensed touch, and output the input signal; a micro control unit for receiving the input signal from the touch pad and converting the input signal into a control signal; a communication module for receiving the control signal from the micro control unit and outputting the control signal to a digital broadcasting set-top box; and a display module for displaying interface information which is received from at least one of the digital broadcasting set-top box and a memory and output via the micro control unit, wherein the micro control unit converts the input signal into the control signal on the basis of touched location information of the input signal and the interface information.

According to another aspect of the present invention, there is provided a digital broadcasting set-top box controlling apparatus comprising: a touch pad that can sense a touch of a user, convert the sensed touch into an input signal corresponding at least one of a location and a state of the sensed touch, and output the input signal; a micro control unit for receiving the input signal from the touch pad and converting the input signal into a control signal; a communication module for receiving the control signal from the micro control unit and outputting the control signal to a digital broadcasting set-top box; and a display module for displaying interface information which is output from the micro control unit, wherein the micro control unit receives at least a portion of on-screen-display (OSD) information from the digital broadcasting set-top box via the communication module and outputs the received portion of the OSD information to the display module, and converts the input signal into the control signal on the basis of touched location information of the input signal and the received portion of the OSD information.

According to still another aspect of the present invention, there is provided a digital broadcasting set-top box controlling apparatus comprising: a touch pad that can sense a touch of a user, convert the sensed touch into an input signal corresponding at least one of a location and a state of the sensed touch, and output the input signal; a micro control unit for receiving the input signal from the touch pad and converting the input signal into a control signal; a communication module for receiving the control signal from the micro control unit and outputting the control signal to a digital broadcasting set-top box; and a display module for displaying interface information which is output from the micro control unit, wherein the micro control unit receives display information from the digital broadcasting set-top box via the communication module and outputs the display information to the display module, and outputs at least one of the touched location information and touch state information included in the input signal input based on an image displayed on the display module, to the digital broadcasting set-top box via the communication module.

According to a further aspect of the present invention, there is provided a digital broadcasting system comprising the above-described digital broadcasting set-top box controlling apparatuses.

According to a still further aspect of the present invention, there is provided a method of driving a digital broadcasting set-top box controlling apparatus, the method comprising: displaying interface information which is received from at least one of a digital broadcasting set-top box and a memory; sensing a touch of a user, converting the sensed touch into an input signal corresponding at least one of a location and a state of the sensed touch, and outputting the input signal; and converting the input signal into a control signal on the basis of touched location information of the input signal and interface information and outputting the control signal to the digital broadcasting set-top box.

According to a yet another aspect of the present invention, there is provided a method of driving a digital broadcasting set-top box controlling apparatus, the method comprising: receiving and displaying at least a portion of OSD information output from a digital broadcasting set-top box; sensing a touch of a user, converting the sensed touch into an input signal corresponding at least one of a location and a state of the sensed touch, and outputting the input signal; and converting the input signal into a control signal on the basis of touched location information of the input signal and the received portion of the OSD information and outputting the control signal to the digital broadcasting set-top box.

According to a still yet another aspect of the present invention, there is provided a method of driving a digital broadcasting set-top box controlling apparatus, the method comprising: receiving display information from a digital broadcasting set-top box and displaying the display information; sensing a touch of a user based on a displayed image and converting the sensed touch into an input signal corresponding at least one of a location and a state of the sensed touch; and outputting at least one of touched location information and touch state information included in the input signal to the digital broadcasting set-top box.

With the apparatuses and methods, point recognition and/pr character recognition can be performed using a touch pad. The apparatuses and methods can perform two-way data communications with a digital broadcasting set-top box instead of outputting an on-way control signal as in an existing remote controller. As a result, an on screen display (OSD) image displayed on a display device can be received and various control operations can be performed by using the received OSD image. In addition, an operation of a digital broadcasting set-top box can be directly performed in the digital broadcasting set-top box controlling apparatus.

### BRIEF DESCRIPTION OF DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 illustrates a digital broadcasting set-top box and an apparatus for controlling the set-top box according to an embodiment of the present invention;

FIG. 2 is a block diagram of a structure of the digital broadcasting set-top box controlling apparatus illustrated in FIG. 1;

FIG. 3 illustrates a remote controller type interface of the digital broadcasting set-top box controlling apparatus illustrated in FIG. 2;

FIG. 4 illustrates a keyboard type interface of the digital broadcasting set-top box controlling apparatus illustrated in FIG. 2;

FIG. 5 illustrates a pattern input interface of the digital broadcasting set-top box controlling apparatus illustrated in FIG. 2;

FIG. 6 illustrates an on-screen-display (OSD) interface of the digital broadcasting set-top box controlling apparatus illustrated in FIG. 2; and

FIG. 7 is a conceptual diagram for describing point control performed by using the digital broadcasting set-top box controlling apparatus illustrated in FIG. 2.

### DETAILED DESCRIPTION OF EMBODIMENTS

The attached drawings for illustrating preferred embodiments of the present invention are referred to in order to gain a sufficient understanding of the present invention, the merits thereof, and the objectives accomplished by the implementation of the present invention. It should be understood that the drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing, unless otherwise specified.

It will be understood that when a component is referred to as “transmitting” data to another component, the component can transmit the data to the other component directly or via at least one other component. In contrast, when a component is referred to as “directly transmitting” data to another component, there are no intervening components via which the data is transmitted from the former component to the latter component.

Hereinafter, the present invention will be described in detail by explaining embodiments of the invention with reference to the attached drawings.

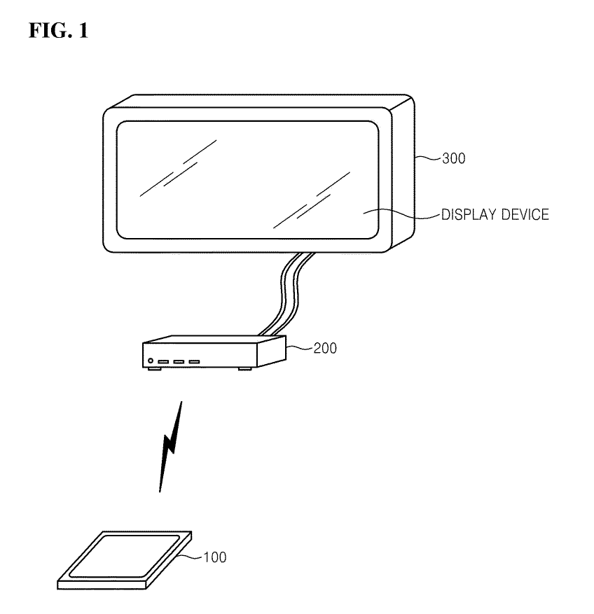

FIG. 1 illustrates a digital broadcasting set-top box 200 and a digital broadcasting set-top box controlling apparatus 100 according to an embodiment of the present invention. Referring to FIG. 1, the digital broadcasting set-top box controlling apparatus 100 may be connected to the digital broadcasting set-top box 200 via wired or wireless communications so that they can transmit to and receive from data. In other words, the digital broadcasting set-top box controlling apparatus 100 may perform two-way communications with digital broadcasting set-top box 200.

The digital broadcasting set-top box 200 may be connected to a display device 300 in a wired or wireless way and output visual information or audio information to the display device 300. The digital broadcasting set-top box 200 may include personal video recorder (PVR) function and may be connected to the Internet via wired/wireless communications.

The digital broadcasting set-top box controlling apparatus 100 may be used as a control device for controlling the digital broadcasting set-top box 200. Also, it may be used as an input device for inputting information, such as characters, numbers, and/or symbols, to the digital broadcasting set-top box 200. For convenience of viewers or users, the digital broadcasting set-top box controlling apparatus 100 may be designed to have such a size and weight as to be put and used on one hand of a viewer or a user.

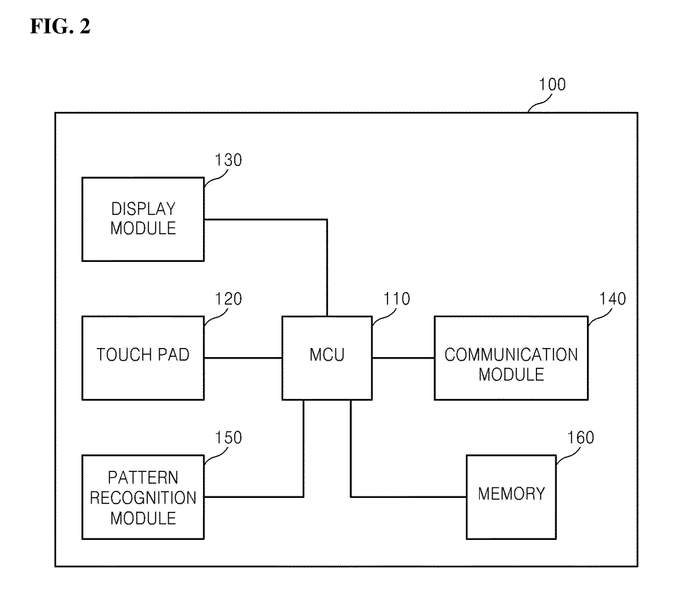

FIG. 2 is a block diagram of a structure of the digital broadcasting set-top box controlling apparatus 100. Referring to FIG. 2, the digital broadcasting set-top box controlling apparatus 100 includes a micro controller unit (MCU) 110, a touch pad 120, and a communication module 140.

The MCU 110 may serve as a central processing unit (CPU) or a control device for controlling the digital broadcasting set-top box controlling apparatus 100. The MCU 100 may have various names, such as a processor, a CPU, etc., according to embodiments or manufacturing companies.

The touch pad 120 may sense a touch of a user, generate a signal corresponding to the tough, and output the signal to the MCU 110. To achieve this, the touch pad 120 may include a touch panel (not shown), a touch panel driver (not shown), a data bus, etc. When a user applies a predetermined pressure on the touch pad 120 by using his or her hand, a touch pad pen, or the like, the touch pad 120 may sense the pressure and output, as an output signal, at least one of information about a touched location and information about a touch state. The information about a touched location includes information about a location on the touch pad 120 from which the pressure is sensed. The information about a touch state includes information about whether the pressure is continuously applied and/or information about a motion of the touched location generated when the pressure has been applied. Of course, the information about a touch state may only include the information about whether the pressure is continuously applied. In this case, the information about the motion of the touched location and/or information about a distance by which the touched location was moved when the pressure was applied may be recognized based on the information about a touched location and the information about a touch state including only the information about whether the pressure is continuously applied. The information about a touched location may be a coordinate on a touch panel (not shown) included in the touch pad 120. The information about a touch state may include at least one of the information about whether the pressure is continuously applied by a user and the information about a motion of the touched location generated when the user has touched according to an embodiment. The touch pad 120 may generate a control signal (e.g., a signal corresponding to movement, clicking, or dragging) for controlling an interface (e.g., an on-screen display (OSD) or a pointer on a browser) of the digital broadcasting set-top box 200, based on information including at least one of the information about a touched location and the information about a touch state.

The communication module 140 is a communication device used in order for the digital broadcasting set-top box 200 and the digital broadcasting set-top box controlling apparatus 100 to transceive data bidirectionally, or software for controlling the communication device. Preferably, the communication module 140 may use wireless communications, such as infrared communications, Bluetooth, or wireless Internet, or wired communications.

The touch pad 120 may sense a touch (e.g., a pressure applied by a hand, a pen, or the like) of a user, convert the sensed touch into an input signal, and output the input signal. The MCU 110 may receive the input signal from the touch pad 120, convert the input signal into a control signal, and output the control signal to the digital broadcasting set-top box 200 via the communication module 140.

The digital broadcasting set-top box controlling apparatus 100 may further include a pattern recognition module 150, a display module 130, and/or a memory 160.

The display module 130 may be implemented as, e.g., a liquid crystal display (LCD) module. The LCD module may include an LCD panel, a driver, etc. The display module 130 may be located below the touch pad 120 from the viewpoint of a user, and the touch pad 120 may be implemented as, e.g., a transparent pad and stacked on the display module 130. Thus, users can feel that they directly touch a user interface (e.g., a button) displayed on the display module 130. The display module 130 may receive interface information from the MCU 110 and display an interface corresponding to the interface information.

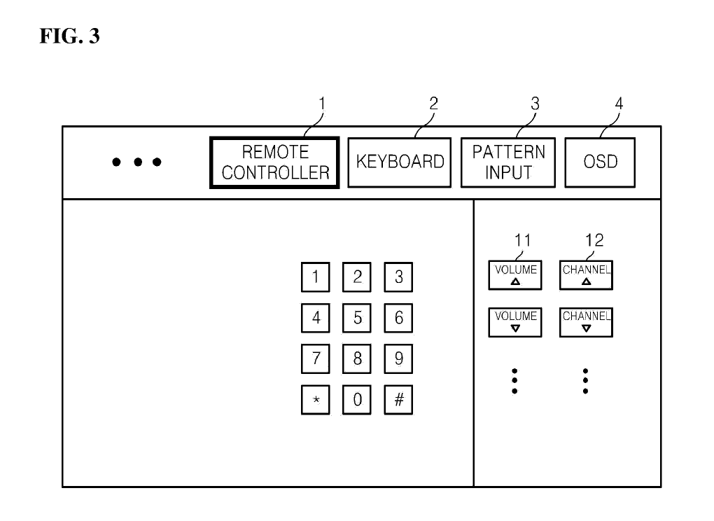

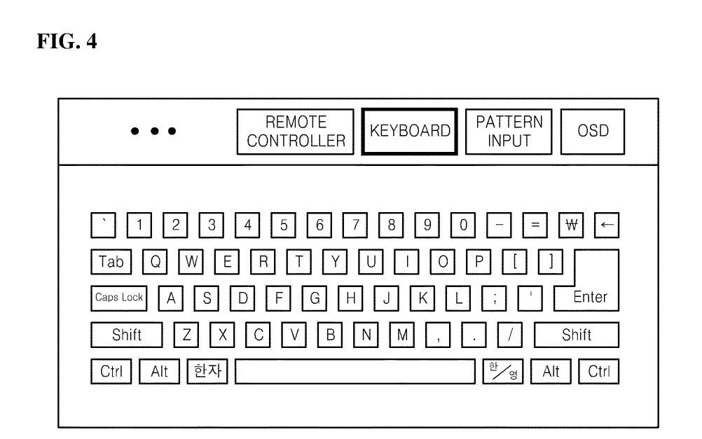

The user may input a predetermined signal to the touch pad 120 by touching based on the interface displayed on the display module 130. The MCU 110 may convert the input signal into a control signal based on the interface information and touched location information which is included in the input signal, and output the control signal. The interface information may be pre-stored in the memory 160 or received from the digital broadcasting set-top box 200. The interface information may be a remote controller type interface as illustrated in FIG. 3 or a keyboard type interface as illustrated in FIG. 4.

Referring to FIGS. 2 through 4, the display module 130 of the digital broadcasting set-top box controlling apparatus 100 may receive interface information previously stored in the memory 160 and display the interface information under the control of the MCU 110. Alternatively, the display module 130 may receive and display interface information (e.g., a remote controller type interface as illustrated in FIG. 3) which is received from the digital broadcasting set-top box 200 and then stored in the memory 160 or a storage device (not shown), under the control of the MCU 110.

The display module 130 may display interfaces for selecting several control modes, for example, interfaces 1, 2, 3, and 4 for selecting a remote controller control mode, a keyboard control mode, a pattern input control mode, and an OSD control mode, respectively. Hereinafter, the interfaces 1, 2, 3, and 4 are referred to as a remote controller interface 1, a keyboard interface 2, a pattern input interface 3, and an OSD interface 4. As illustrated in FIG. 3, each of the remote controller interface 1, the keyboard interface 2, the pattern input interface 3, and the OSD interface 4 may be a button-type graphic user interface (GUI). However, the present invention is not limited to this example, and various modifications in the type of each of the interfaces 1, 2, 3, and 4 may be made.

When a user touches a location on the touch pad 120, which corresponds to a location of the remote controller interface 1 displayed on the display module 130 (i.e., a portion of the touch pad 120 located directly over the remote controller interface 1), a remote controller type interface as illustrated in FIG. 3 may be displayed, and information about the remote controller type interface may be previously stored in the memory 160. Of course, the memory 160 may receive the information about the remote controller type interface from the digital broadcasting set-top box 200 and store the information.

When the user touches a portion of the touch pad 120 corresponding to a volume-up interface 11 on the remote controller type interface displayed on the display module 130, the MCU 110 may convert to a control signal an input signal corresponding to the touch into a control signal (that is, a volume-up control signal) based on the interface information (that is, information about the remote controller type interface and a location of the volume-up interface 11) and touched location information (that is, a touched location on the touch pad 120) of the input signal. Even when the user touches a portion of the touch pad 120 corresponding to a channel-up interface 12 on the remote controller type interface displayed on the display module 130, the MCU 110 may convert to a control signal an input signal corresponding to the touch into a control signal (that is, a channel-up control signal), based on the interface information and the touched location information (that is, a touched location on the touch pad 120). Then, the digital broadcasting set-top box 200 may receive the control signal and perform a control operation (for example, a volume-up or channel-up operation) corresponding to the control signal.

When the user touches a location on the touch pad 120 corresponding to a location of the keyboard interface 2 of the display module 130 (i.e., a portion of the touch pad 120 located directly over the keyboard interface 2), a keyboard type interface as illustrated in FIG. 4 may be displayed, and information about the keyboard type interface may be previously stored in the memory 160. Of course, the memory 160 may receive the information about the keyboard type interface from the digital broadcasting set-top box 200 and store the information.

Then, the user may input characters, numbers, symbols, etc. by using a displayed GUI. A method of inputting the characters, numbers, symbols, etc. is similar to what described above with reference to FIG. 3, and thus a detailed description thereof will be omitted.

In other words, the digital broadcasting set-top box controlling apparatus 100 can provide an input interface based on point recognition by using the GUI illustrated in FIG. 3 or 4 and the touch pad 120.

In addition, the memory 160 may store not the remote controller type interface or keyboard type interface illustrated in FIG. 3 or 4 but also various pieces of GUI information according to various embodiments and various user requests. Of course, the digital broadcasting set-top box controlling apparatus 100 may receive information about the remote controller type interface or keyboard type interface and stored the information in the memory 160 or a predetermined storage device (not shown).

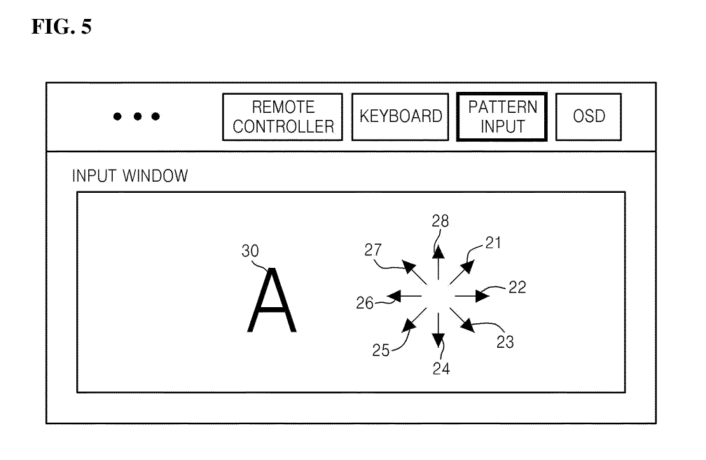

The digital broadcasting set-top box controlling apparatus 100 can provide not only the input interface based on point recognition but also an input interface based on pattern recognition. FIG. 5 illustrates a pattern input interface of the digital broadcasting set-top box controlling apparatus 100.

Referring to FIGS. 2 and 5, the MCU 110 may receive the input signal from the touch pad 120 and output the control signal corresponding to moving, clicking, or dragging to the digital broadcasting set-top box 200 via the communication module 140 on the basis of at least one of touched location information and touch state information which are included in the input signal.

For example, the user may perform one of touch actions 21 through 28 on the touch pad 120 by using a user's finger or an input pen. Then, in a current mode of the digital broadcasting set-top box 200, the MCU 110 may convert an input signal corresponding to the performed touch action into a control signal (e.g., a control signal corresponding to moving) and output the control signal.

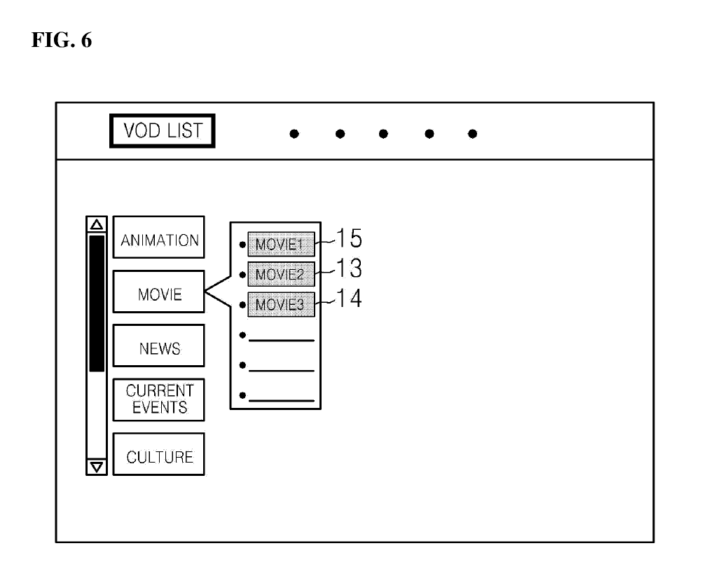

For example, when the current mode is a mode for displaying a video on demand (VOD) list as illustrated in FIG. 6 and “Movie 2” is currently selected, an area corresponding to “movie 2” may be displayed as a predetermined interface (for example, a highlighted or reverse-colored character 13) in order to represent selection of “movie 2”.

In this case, if the user performs one of the touch actions (for example, the touch action 21, 28, or 27) on the touch pad 120, the predetermined interface (for example, the highlighted or reverse-colored character 13) may be transformed so as to represent “movie 1”. In other words, the interface 13 corresponding to “movie 2” may disappear, and an interface 15 corresponding to “movie 1” may be generated.

In order to achieve this, the MCU 110 may analyze information such as a direction and duration of a user's touch by using touched location information or touch state information which are included in an input signal corresponding to the touch action (for example, the touch action 21, 28, or 27), and generate a control signal corresponding to the analyzed information.

Meanwhile, if the user performs one of the touch actions (for example, the touch action 23, 24, or 25) on the touch pad 120, “movie 3” is selected, and an interface 14 corresponding to “movie 3” may be generated.

If the user performs one of the touch actions (for example, the touch action 26) on the touch pad 120, an upper menu (for example, “movie” of a currently selected item (for example, “movie 2”) may be selected.

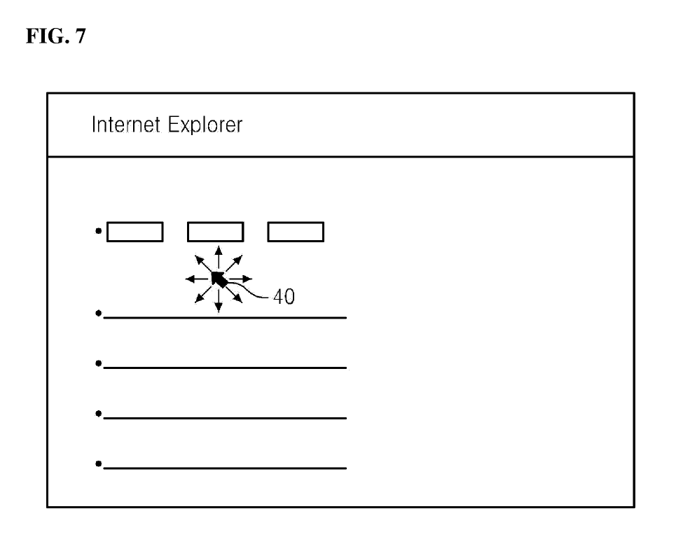

For example, if the current mode is a mode in which a web browser is activated as illustrated in FIG. 7, the user may perform one of the touch actions 21 through 28 on the touch pad 120 in order to control an interface 40, and the MCU 110 may receive an input signal corresponding to the performed touch action and output a control signal (for example, a control signal corresponding to moving) corresponding to the input signal.

The user may perform a touch action corresponding to clicking through the touch pad 120. For example, the digital broadcasting set-top box controlling apparatus 100 may display an interface (for example, a button-type GUI) corresponding to clicking and perform an operation corresponding to the clicking when the user touches the interface corresponding to clicking. Alternatively, the MCU 110 may determine whether clicking has been performed, according to the length of a touching duration, which is included in touch state information included in an input signal. Alternatively, if two touches are consecutively made for a predetermined period of time, it may be determined that clicking has been performed.

Similarly, it is determined that dragging has been performed, when a touch corresponding to movement is made in a state where a portion of the touch pad 120 corresponding to a predetermined GUI corresponding to dragging has been depressed. Alternatively, if two or more areas on the touch pads 120 are touched simultaneously, the MCU 110 may control dragging to be performed in directions of the touched areas.

Depending on the type of embodiment, this pattern recognition may be performed in the MCU 110 or in the pattern recognition module 150. If the pattern recognition is performed in the pattern recognition module 150, the MCU 110 may transmit the received input signal to the pattern recognition module 150, and the pattern recognition module 150 may identify an operation corresponding to the input signal and transmit a result of the identification to the MCU 110.

Alternatively, the pattern recognition module 150 may receive the input signal from the patch pad 120, recognize a pattern of the input signal, and output information about a character corresponding to the pattern to the MCU 150.

For example, if the user inputs a pattern 30 similar to “A” as illustrated in FIG. 5, the pattern recognition module 150 may recognize the pattern 30 based on touched location information included in the input signal, compare the recognized pattern with a pre-stored pattern, and recognize a character corresponding to the input pattern 30. Of course, the pattern recognition module 150 may include a conventional character recognition program or the like and capture an input pattern in the form of an image so as to perform character recognition. In some embodiments, the digital broadcasting set-top box 200 may perform a role of the pattern recognition module 150.

In other words, the MCU 110 included in the digital broadcasting set-top box controlling apparatus 100 may generate a pattern corresponding to the input signal and output the pattern to the digital broadcasting set-top box 200. The pattern may include information about coordinates for representing the trace of a user's touch. The information about the coordinates itself may be output to the digital broadcasting set-top box 200, or the trace of the user's touch may be output in the form of an image to the digital broadcasting set-top box 200.

According to embodiments, when a data processing ability (for example, an ability to perform an arithmetic operation for pattern recognition) of the digital broadcasting set-top box 200 is higher than that of the digital broadcasting set-top box controlling apparatus 100, pattern recognition may be performed in the digital broadcasting set-top box 200.

As described above, the digital broadcasting set-top box controlling apparatus 100 may generate not only a control signal (for example, a control signal corresponding to movement, clicking, or dragging) for controlling the digital broadcasting set-top box 200 but also a signal (for example, a signal corresponding a character, a number, or a symbol) for inputting predetermined information.

FIG. 6 illustrates an OSD-used interface of the digital broadcasting set-top box controlling apparatus 100 illustrated in FIG. 2. Referring to FIGS. 2 and 6, the MCU 110 may receive at least a portion of OSD information from the digital broadcasting set-top box 200 via the communication module 140 and output the portion of the OSD information to the display module 130.

The OSD information includes information about a GUI displayed on the display device 300, and may be pre-stored in the digital broadcasting set-top box 200. Accordingly, the display module 130 of the digital broadcasting set-top box controlling apparatus 100 may display the same GUI as the GUI displayed on the display device 300.

In some cases, the digital broadcasting set-top box controlling apparatus 100 may receive only a portion of the OSD information from the digital broadcasting set-top box 200 and allow only the received portion of the OSD information to be displayed on the display module 130. For example, if OSD information as illustrated in FIG. 6 is displayed on the display device 300 while a user is watching a broadcasting program, the user is interrupted, and thus the OSD information may be controlled to be displayed on only the digital broadcasting set-top box controlling apparatus 100 instead of on the display device 300. In some embodiments, only a portion of the OSD information may be controlled to be displayed on the digital broadcasting set-top box controlling apparatus 100.

When a GUI as illustrated in FIG. 6 is displayed on the display device 300 and a user touches the OSD interface 4 of FIG. 3, the digital broadcasting set-top box controlling apparatus 100 may receive the OSD information from the digital broadcasting set-top box 200. Thus, the GUI as illustrated in FIG. 6 may also be displayed on the digital broadcasting set-top box controlling apparatus 100. Of course, as described above, only a portion of the GUI may be displayed on the digital broadcasting set-top box controlling apparatus 100.

Then, the user may perform a predetermined touch action based on the GUI displayed on the digital broadcasting set-top box controlling apparatus 100. For example, when the GUI displayed on the display module 130 is as illustrated in FIG. 6 and the user touches a portion of the touch pad 120 corresponding to a button “movie”. lower items (for example, “movie 1”?through “movie 3”) of the button “movie” may be displayed as illustrated in FIG. 6.

To achieve this, the MCU 110 may convert an input signal corresponding to the user's touch into a control signal, based on touched location information of the input signal and the OSD information, and output the control signal. In other words, the MCU 110 may extract an interface (for example, the button “movie”) corresponding to the input signal from the OSD information on the basis of the touched location information of the input signal and then output a control signal for selecting the button “movie” to the digital broadcasting set-top box 200.

In some embodiments, the digital broadcasting set-top box controlling apparatus 100 may independently perform a program by using the digital broadcasting set-top box 200. For example, if the digital broadcasting set-top box 200 is able to be connected to the Internet and execute a web browser, a web browser as illustrated in FIG. 7 may be activated in the digital broadcasting set-top box 200. Accordingly, the web browser as illustrated in FIG. 7 may be displayed on the display device 300 connected to the digital broadcasting set-top box controlling apparatus 100.

Then, the digital broadcasting set-top box 200 may generate, as display information, an image (for example, the web browser as illustrated in FIG. 7) being displayed on the display device 300. For example, the digital broadcasting set-top box 200 may generate display information output to the display device 300 in the form of an image file and output the image file to the digital broadcasting set-top box controlling apparatus 100. Alternatively, the digital broadcasting set-top box 200 may output the display information, which is output later to the display device 300, to the digital broadcasting set-top box controlling apparatus 100.

The MCU 110 may then receive the display information from the digital broadcasting set-top box 200 via the communication module 140 and output the display information to the display module 130 so that the same image as an image being displayed on the display device 300 can be displayed on the digital broadcasting set-top box controlling apparatus 100. In other words, as described above, not only the OSD information but also the same image as the image being displayed on the display device 300 may be displayed on the digital broadcasting set-top box controlling apparatus 100.

Then, the user may input a predetermined touch by using the touch pad 120, based on the image displayed on the display module 130. Then, the MCU 110 may output at least one of the touched location information and the touch state information included in an input signal corresponding to the input touch, to the digital broadcasting set-top box 200 via the communication module 140. In other words, the user can see the same image as that displayed on the display device 300 even on the digital broadcasting set-top box controlling apparatus 100. In addition, the user can apply a pressure while watching the display device 300 and also can apply a pressure while watching the digital broadcasting set-top box controlling apparatus 100.

At least one of the touched location information and touch state information included in the input signal input by the user to the digital broadcasting set-top box controlling apparatus 100 may be output again to the digital broadcasting set-top box 200. The digital broadcasting set-top box 200 may receive at least one of the touched location information and touch state information and perform a predetermined operation on the basis of the received information.

For example, the web browser as illustrated in FIG. 7 may be displayed on the display device 300 and the digital broadcasting set-top box controlling apparatus 100. Then, the user may perform a predetermined touch action (for example, the touch action 28 representing an upward movement) as illustrated in FIG. 5. Then, the digital broadcasting set-top box controlling apparatus 100 may output information about the predetermined touch action to the digital broadcasting set-top box 200. The digital broadcasting set-top box 200 may receive the information about the predetermined touch action and perform an operation (for example, an operation of moving the pointer 40 upward) corresponding to the predetermined touch action. The digital broadcasting set-top box 200 may transmit display information about an image obtained after the execution of the operation corresponding to the predetermined touch action, to the digital broadcasting set-top box controlling apparatus 100. Thus, an image displayed on the digital broadcasting set-top box controlling apparatus 100 may be the image obtained after the execution of the operation corresponding to the predetermined touch action.

In some embodiments, the digital broadcasting set-top box 200 may transmit the display information to the digital broadcasting set-top box controlling apparatus 100 in real time. Only when a predetermined signal is input through the digital broadcasting set-top box controlling apparatus 100, the digital broadcasting set-top box 200 may perform an operation corresponding to the input signal and continuously transmit the display information to the digital broadcasting set-top box controlling apparatus 100 in real time.

Accordingly, the digital broadcasting set-top box controlling apparatus 100 may directly perform a predetermined program (for example, a web browser). The predetermined program may be not only the exemplified web browser but also all kinds of contents that can be displayed on the screen of a display device. In other words, not only a specific program but also all kinds of images being displayed on the display device 300 may be displayed on the digital broadcasting set-top box controlling apparatus 100.

Therefore, the user can communicate with the digital broadcasting set-top box 200. However, when the user is in a location where the user cannot see a currently displayed image, the user can see the currently displayed image by using the digital broadcasting set-top box controlling apparatus 100 and control the digital broadcasting set-top box 200.

A method of driving a digital broadcasting set-top box controlling apparatus according to the present invention can be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A digital broadcasting set-top box controlling apparatus comprising:
a touch pad that can sense a touch of a user, convert the sensed touch into an input signal corresponding at least one of a location and a state of the sensed touch, and output the input signal;
a micro control unit for receiving the input signal from the touch pad and converting the input signal into a control signal;
a communication module for receiving the control signal from the micro control unit and outputting the control signal to a digital broadcasting set-top box; and
a display module for displaying interface information which is received from at least one of the digital broadcasting set-top box and a memory and output via the micro control unit,
wherein the micro control unit converts the input signal into the control signal on the basis of touched location information of the input signal and the interface information.

2. The digital broadcasting set-top box controlling apparatus of claim 1, wherein the micro control unit receives the input signal from the touch pad and outputs the control signal corresponding to one of moving, clicking, and dragging on the basis of at least one of the touched location information and touch state information which are included in the input signal.

3. A digital broadcasting set-top box controlling apparatus comprising:
a touch pad that can sense a touch of a user, convert the sensed touch into an input signal corresponding at least one of a location and a state of the sensed touch, and output the input signal;
a micro control unit for receiving the input signal from the touch pad and converting the input signal into a control signal;
a communication module for receiving the control signal from the micro control unit and outputting the control signal to a digital broadcasting set-top box; and
a display module for displaying interface information which is output from the micro control unit,
wherein the micro control unit receives at least a portion of on-screen-display (OSD) information from the digital broadcasting set-top box via the communication module and outputs the received portion of the OSD information to the display module, and converts the input signal into the control signal on the basis of touched location information of the input signal and the received portion of the OSD information.

4. A digital broadcasting set-top box controlling apparatus comprising:
a touch pad that can sense a touch of a user, convert the sensed touch into an input signal corresponding at least one of a location and a state of the sensed touch, and output the input signal;
a micro control unit for receiving the input signal from the touch pad and converting the input signal into a control signal;
a communication module for receiving the control signal from the micro control unit and outputting the control signal to a digital broadcasting set-top box; and
a display module for displaying interface information which is output from the micro control unit,
wherein the micro control unit receives display information from the digital broadcasting set-top box via the communication module and outputs the display information to the display module, and outputs at least one of the touched location information and touch state information included in the input signal input based on an image displayed on the display module, to the digital broadcasting set-top box via the communication module.

5. A method of driving a digital broadcasting set-top box controlling apparatus, the method comprising:
displaying interface information which is received from at least one of a digital broadcasting set-top box and a memory;
sensing a touch of a user, converting the sensed touch into an input signal corresponding at least one of a location and a state of the sensed touch, and outputting the input signal; and
converting the input signal into a control signal on the basis of touched location information of the input signal and interface information and outputting the control signal to the digital broadcasting set-top box.

6. The method of claim 5, further comprising:
determining whether the input signal corresponds to moving, clicking, or dragging, on the basis of at least one of the touched location information and touch state information which are included in the input signal,
wherein the control signal may be a signal corresponding to moving, clicking, or dragging based on the determined result.

7. The method of claim 5, further comprising:
recognizing a pattern of the received input signal; and
outputting information about a character corresponding to the recognized pattern to the digital broadcasting set-top box.

8. The method of claim 5, further comprising:
generating a pattern corresponding to the received input signal; and
outputting the generated pattern to the digital broadcasting set-top box.

9. A method of driving a digital broadcasting set-top box controlling apparatus, the method comprising:
receiving and displaying at least a portion of OSD information output from a digital broadcasting set-top box;
sensing a touch of a user, converting the sensed touch into an input signal corresponding at least one of a location and a state of the sensed touch, and outputting the input signal; and
converting the input signal into a control signal on the basis of touched location information of the input signal and the received portion of the OSD information and outputting the control signal to the digital broadcasting set-top box.

10. A method of driving a digital broadcasting set-top box controlling apparatus, the method comprising:
receiving display information from a digital broadcasting set-top box and displaying the display information;
sensing a touch of a user based on a displayed image and converting the sensed touch into an input signal corresponding at least one of a location and a state of the sensed touch; and
outputting at least one of touched location information and touch state information included in the input signal to the digital broadcasting set-top box.

11. A digital broadcasting system comprising the digital broadcasting set-top box controlling apparatus of claim 1.

12. A digital broadcasting system comprising the digital broadcasting set-top box controlling apparatus of claim 2.

13. A digital broadcasting system comprising the digital broadcasting set-top box controlling apparatus of claim 3.

14. A digital broadcasting system comprising the digital broadcasting set-top box controlling apparatus of claim 4.
